(19) United States
(12) Patent Application Publication
(10) Pub. No.: US 2025/0043726 A1
(43) Pub. Date: Feb. 6, 2025

(54) CONTAINMENT RING CAVITY PRESSURIZATION SYSTEM

(71) Applicant: Pratt & Whitney Canada Corp., Longueuil (CA)

(72) Inventors: Philippe Savard, Montréal (CA); Guy Lefebvre, St-Bruno (CA); Christopher John Gover, Longueuil (CA); Remy Synnott, St-Jean-sur-Richelieu (CA)

(21) Appl. No.: 18/365,299

(22) Filed: Aug. 4, 2023

(51) Int. Cl. F02C 7/18; F02C 3/04; F02C 7/28

(52) U.S. Cl. CPC F02C 7/18; F02C 3/04; F02C 7/28; F05D 2260/20

(57) ABSTRACT

Aircraft engines and methods of operation thereof are described. The aircraft engines include a fan section, a combustion section, a compressor section comprising an impeller, and a turbine section comprising a vane assembly and a containment cavity defined radially outward from the vane assembly. The fan section, the combustion section, the compressor section, and the turbine section are arranged along an engine axis and an engine shaft operably connects the turbine section to the fan section. Cooling air is supplied from the impeller to an inner diameter of the vane assembly, passed through at least one vane of the vane assembly, and into the containment cavity.

### BACKGROUND

The subject matter disclosed herein generally relates to aircraft engines and, more particularly, to containment ring cavity pressurization systems for use in aircraft engines.

Aircraft engines such as gas turbine engines and turbofan engines operate at high temperatures and thus components of the engines must be cooled sufficiently to ensure proper operation, efficiency, and engine life. Typically, containment cavities that are defined within portions or sections of an aircraft engine may be cooled and pressurized using a source of air from external tubing or from specific holes in casing wall(s) that surround the containment cavities. However, current hot section design for aircraft engines does not allow air to flow directly into some containment cavities due to the hot section configuration. That is, due to the structural arrangement of the components of the engine, and particularly the hot section components, conventional tubing and/or cooling holes may not be a viable solution without substantially negatively impacting engine performance and/or are not feasible due to the arrangement of components (i.e., no space for such tubing or the like). Accordingly, improved cooling schemes are desirable for implementation with aircraft engines.

### SUMMARY

According to some embodiments aircraft engines are provided. The aircraft engines include a fan section, a combustion section, a compressor section comprising an impeller, and a turbine section comprising a vane assembly and a containment cavity defined radially outward from the vane assembly. The fan section, the combustion section, the compressor section, and the turbine section are arranged along an engine axis and an engine shaft operably connects the turbine section to the fan section. Cooling air is supplied from the impeller to an inner diameter of the vane assembly, passed through at least one vane of the vane assembly, and into the containment cavity.

In addition to one or more of the features described herein, or as an alternative, further embodiments of the aircraft engines may include a bearing housing arranged between the compressor section and the turbine section, the bearing housing defining a bearing cavity, wherein the cooling air is directed through the bearing cavity between the impeller and the inner diameter of the vane assembly.

In addition to one or more of the features described herein, or as an alternative, further embodiments of the aircraft engines may include that the bearing housing is configured to connect to a housing of the turbine section at a joint.

In addition to one or more of the features described herein, or as an alternative, further embodiments of the aircraft engines may include a fluid path through the joint.

In addition to one or more of the features described herein, or as an alternative, further embodiments of the aircraft engines may include that the fluid path is a transfer tube.

In addition to one or more of the features described herein, or as an alternative, further embodiments of the aircraft engines may include that the cooling air is extracted from air compressed by the impeller, wherein a majority of the compressed air is directed to the combustion section.

In addition to one or more of the features described herein, or as an alternative, further embodiments of the aircraft engines may include that the cooling air is directed from the impeller into a gap between a structure of the impeller and a portion of a compressor section case of the compressor section.

In addition to one or more of the features described herein, or as an alternative, further embodiments of the aircraft engines may include a vane assembly plenum defined at an inner diameter of the vane assembly.

In addition to one or more of the features described herein, or as an alternative, further embodiments of the aircraft engines may include that the vane assembly plenum is sealed by at least one seal.

In addition to one or more of the features described herein, or as an alternative, further embodiments of the aircraft engines may include that the at least one seal is a W-seal.

In addition to one or more of the features described herein, or as an alternative, further embodiments of the aircraft engines may include that an air pressure within the vane assembly plenum is maintained at a pressure greater than an air pressure within the containment cavity.

According to some embodiments, methods for supplying cooling air into containment cavities of aircraft engines are provided. The methods include extracting a cooling air from air compressed by an impeller of the aircraft engine, passing the cooling air aftward to an inner diameter of a vane assembly, and passing the cooling air radially outward through at least one vane of the vane assembly and into the containment cavity.

In addition to one or more of the features described herein, or as an alternative, further embodiments of the methods may include that the aircraft engine comprises a fan section, a combustion section, a compressor section comprising the impeller, and a turbine section comprising the vane assembly and the containment cavity is defined radially outward from the vane assembly.

In addition to one or more of the features described herein, or as an alternative, further embodiments of the methods may include that a bearing housing is arranged between the compressor section and the turbine section, the bearing housing defining a bearing cavity, the method comprising directing the cooling air through the bearing cavity between the impeller and the inner diameter of the vane assembly.

In addition to one or more of the features described herein, or as an alternative, further embodiments of the methods may include directing 10% or less of the compressed air the containment cavity, with the remaining 90% or greater of the compressed air being directed a combustion section of the aircraft engine.

In addition to one or more of the features described herein, or as an alternative, further embodiments of the methods may include that the cooling air is directed from the impeller into a gap between a structure of the impeller and a portion of a compressor section case of a compressor section of the aircraft engine.

In addition to one or more of the features described herein, or as an alternative, further embodiments of the methods may include maintaining an air pressure within a vane assembly plenum defined at an inner diameter of the vane assembly at a higher air pressure than an air pressure within the containment cavity.

In addition to one or more of the features described herein, or as an alternative, further embodiments of the methods may include sealing the vane assembly plenum with at least one seal.

In addition to one or more of the features described herein, or as an alternative, further embodiments of the methods may include that the at least one seal is a W-seal.

In addition to one or more of the features described herein, or as an alternative, further embodiments of the methods may include directing the cooling air from the containment cavity into a hot gas path of the aircraft engine.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1A is a schematic illustration of an aircraft engine in accordance with an embodiment of the present disclosure;

FIG. 1B is a schematic illustration of the aircraft engine of FIG. 1A, indicating flow paths of air through the aircraft engine;

FIG. 2A is an enlarged illustration of a portion of an aircraft engine in accordance with an embodiment of the present disclosure;

FIG. 2B is a schematic illustration of the portion of the aircraft engine of FIG. 2A, indicating flow paths of air through the aircraft engine;

FIG. 3A is a schematic illustration of a vane assembly in accordance with an embodiment of the present disclosure; and

FIG. 3B is an alternative view of the vane assembly of FIG. 3A.

### DETAILED DESCRIPTION

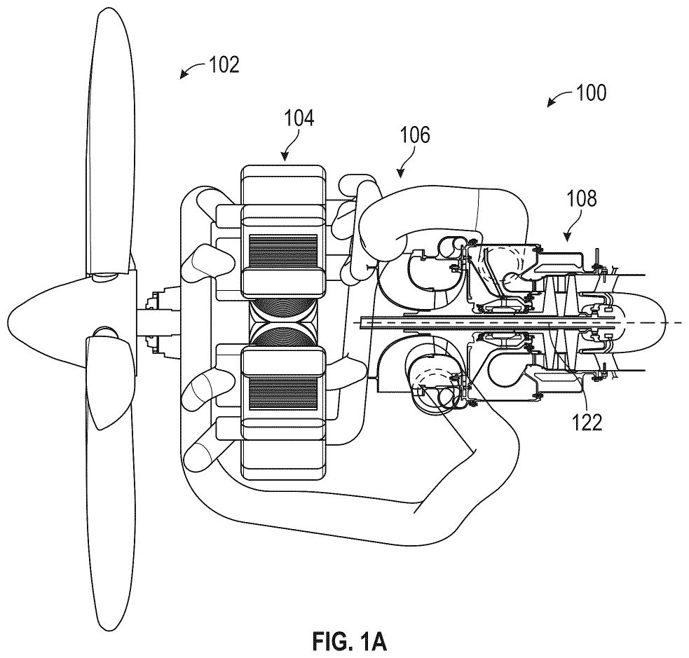

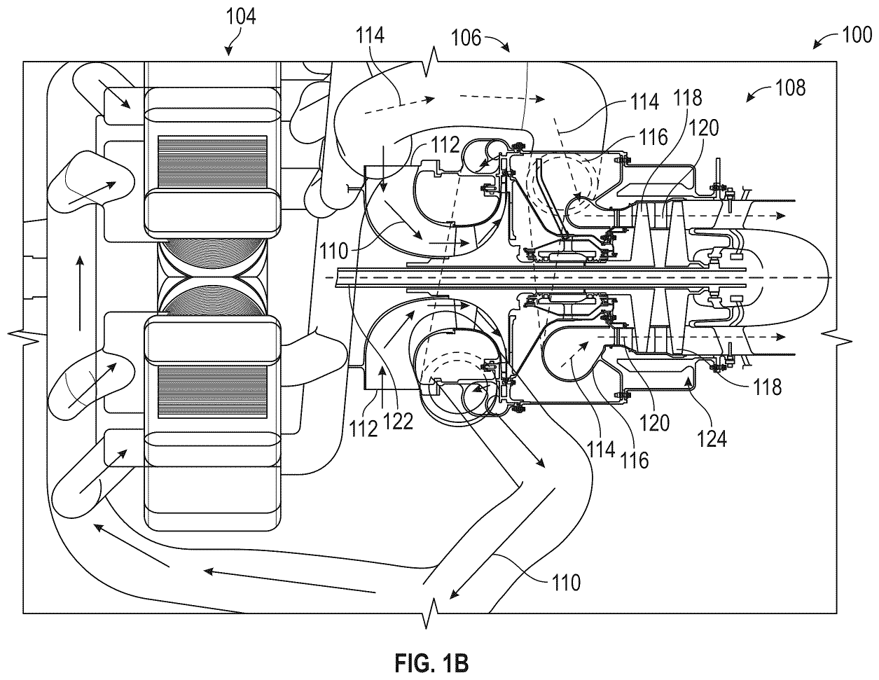

FIG. 1A is a schematic illustration of an aircraft engine 100 that may incorporate embodiments of the present disclosure. The aircraft engine 100 includes a fan section 102, a combustion section 104, a compressor section 106, and a turbine section 108. The aircraft engine 100 may be mounted to an aircraft fuselage and operationally driven to provide propulsive or motive force for flight of the aircraft. During operation, the combustion section 104 will combust a fuel that is mixed with air. In this illustrative configuration of the aircraft engine 100, air may be compressed in the compressor section 106 and the compressed air may be then directed into the combustion section 104 for combustion with the fuel. The combusted fuel and air mixture will then be directed into and through the turbine section 108 to drive an engine shaft 122 or the like, which in turn will cause rotation of the fan section 102. Although the engine shaft 122 is illustratively shown as not connected to the fan section 102 of the aircraft engine 100, those of skill in the art will appreciate that this is merely schematic and the engine shaft 122 may be directly coupled to a fan rotor or the like or may be connected thereto through a gear system or the like. The engine shaft 122 defines an engine axis, engine centerline, or central axis thereof. The fan section 102, combustion section 104, compressor section 106, and the turbine section 108 may all be full circumferent or hoop structures arranged about the engine axis, with the fan section 102 at the forward end and the turbine section 108 at the aft end. The radially direction is an outward direction from the engine axis (or engine shaft 122) and the axial direction is parallel to the direction of the engine axis.

FIG. 1B is an enlarged schematic illustration of a portion of the aircraft engine 100, illustrating an airflow through a portion of the aircraft engine 100. As shown, cold air 110 may be supplied or directed into the compressor section 106 at a cold air inlet 112. The cold air 110 is compressed within the compressor section 106 and directed and supplied into the combustion section 104 for the mixing and combustion with fuel. The output of the combustion section 104 is hot gas 114 (e.g., combusted fuel and air mixture). The hot gas 114 is directed from the combustion section 104 into the turbine section 108 through one or more hot gas inlets 116. The hot gas 114 will then pass through a set or series of turbine blades 118 and vanes 120 of the turbine section 108. As the hot gas 114 is passed through the turbine blades 118 and vanes 120, the turbine blades 118 will be rotated and drive rotation of an engine shaft 122 which may be operably coupled or connected to the fan section 102 to drive rotation of a fan to generate thrust, as will be appreciated by those of skill in the art.

In the illustrative configuration of the aircraft engine 100, and as shown in FIG. 1B, a containment cavity 124 may be defined radially outward, external to, or at an outer diameter of a portion of the turbine section 108. The containment cavity 124 may be defined external to a hot gas path through which the hot gas 114 passes. Conventionally, the containment cavity 124 may be supplied with cooling air from an external location and through tubing or the like. However, due to volume constraints and the arrangement of operational components of the aircraft engine 100, inclusion of such tubing may be a challenge. In view of this, and other considerations, embodiments of the present disclosure provide for a cooling scheme for aircraft engines.

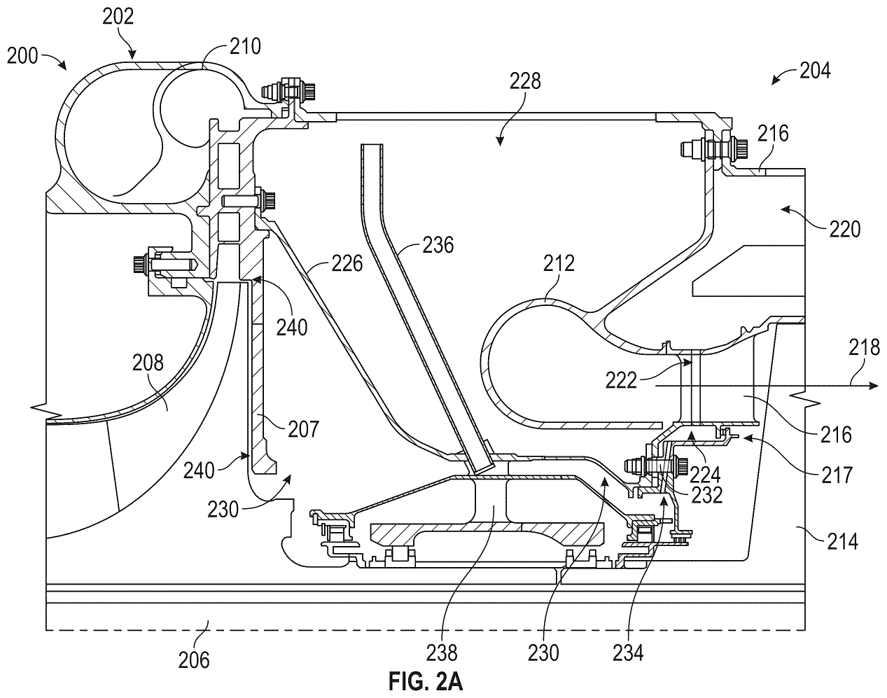

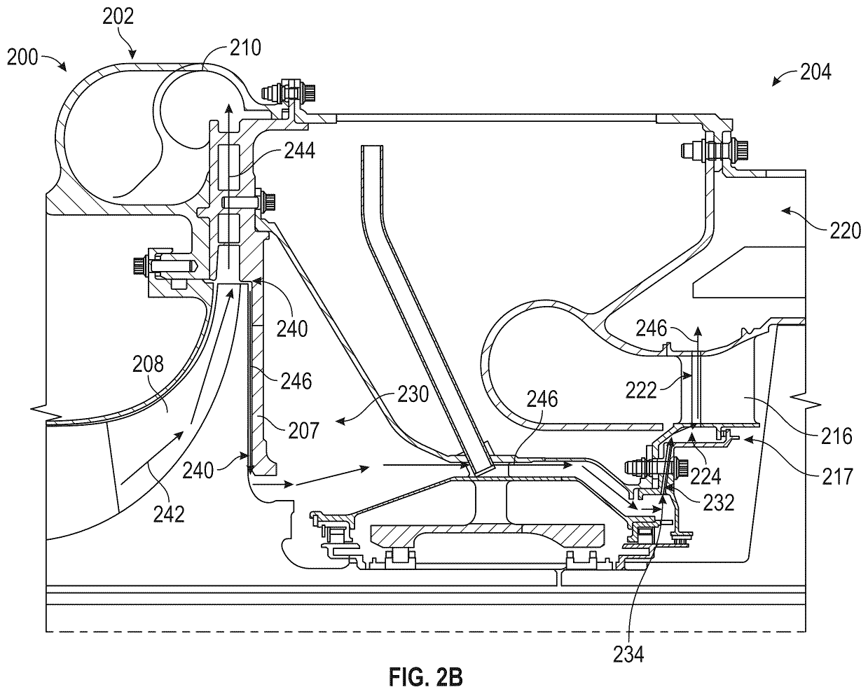

Referring now to FIG. 2A, a schematic illustration of a portion of an aircraft engine 200 in accordance with an embodiment of the present disclosure. The aircraft engine 200 may be similar to the aircraft engine 100 shown and described above. In the illustration of FIG. 2A, a portion of a compressor section 202 and a portion of a turbine section 204 are shown. As shown in FIGS. 1A-1B, a combustion section may be arranged axial forward from the compressor section 202 along an engine shaft 206. The compressor section 202 includes a cold air impeller 208 and a combustion section inlet 210 that directs compressed cold air into the combustion section of the aircraft engine 200. The compressor section 202 includes a compressor section case 207.

As described above, the cold air from the compressor section 202 will be mixed and combusted with fuel to generate a hot gas that is directed toward the turbine section 204 through a hot gas scroll 212. The hot gas scroll 212 is arranged to direct the hot gas from the combustion section into the turbine section 204 to drive rotation of one or more turbine blades 214. Arranged axially adjacent to the turbine blades 214 are vanes 216 that are arranged to direct and control a flow of the hot gas through the turbine section 204. The turbine blades 214 may be operably coupled to the engine shaft 206 by respective rotor disks or the like, as will be appreciated by those of skill in the art.

The aircraft engine 200 includes an engine case 216 that houses various of the components of the aircraft engine 200. The engine case 216 may be arranged as a set of separate case sections that are attached together to form the aircraft engine 200. As shown, a portion of the engine case 216 is arranged radially outward from the turbine blades 214 and vanes 216 which are arranged along and define, in part, a hot gas path 218 through the turbine section 204. Radially outward from the hot gas path 218 and radially inward from the engine case 216, and axially extending along at least a portion of the turbine section 204, is a containment cavity 220. It is desirable to provide cold or cool air into the containment cavity 220 to ensure that the aircraft engine 200 is maintained at appropriate temperatures for part life, engine efficiency, and the like.

In prior configurations, the containment cavities are typically cooled and pressurized using a source of air from external tubing or from specific holes in the adjacent casing wall. However, the turbine section 204 of the aircraft engine 200 does not allow air to flow directly into the containment cavity 220 due to the configuration of the turbine section 204. In view of this, embodiments of the present disclosure are directed to directing cooling air from the compressor section 202 to enter the containment ring cavity 200 in an acceptable limit and provide cooling thereto, without the use of external tubing or the like. In accordance with non-limiting embodiments, pressurized cool air may be supplied from the compressor section 202 to the containment cavity 220 without adding a cooling tube or the like, which increases the complexity of the system. For example, cooled air may be directed from the impeller 208 of the compressor section 202, passed through a bearing housing 230 between the compressor section 202 and the turbine section 204, and then through a transfer tube 222 in at least one vane 216 of a vane assembly 217 into the containment ring cavity 220. In such configurations, the vane assembly 217 may include a vane assembly plenum 224 at a radially inward side thereof, to provide a volume in which pressure of the cooling air may be increased before passing through the vane 216 and into the containment cavity 220.

As shown, the aircraft engine 200 includes a bearing housing 226 that connects, in part, a portion of the compressor section 202 with the turbine section 204. Radially outward from the bearing housing 226 is a first cavity 228 and radially inward from the bearing housing 226 is the bearing cavity 230. In some configurations, the first cavity 228 may be a relatively open cavity that is open to a nacelle compartment and/or open to ambient air. The bearing cavity 230 extends axially to a joint 232 where the bearing housing 226 joins to the structure of the turbine section 204. The joint 232 may include a transfer tube 234 or similar flow path such (e.g., holes, apertures, or the like) that fluidly connects a downstream or aft end of the bearing cavity 230 with the vane assembly plenum 224 of the vane assembly 217. As shown, an oil tube 236 is arranged within the first cavity 228 and extends through a portion of the bearing cavity 230 to provide oil (e.g., for lubrication) to a bearing housing 238 that contains one or more bearings therein.

As shown in FIG. 2A, the bearing cavity 230 is defined at a radially outward limit by the bearing housing 226. At a forward end of the bearing cavity 230 the compressor section case 207 extends in the radial direction (e.g., inward toward the engine shaft 206). A gap 240 is defined between the radial section of the compressor section case 207 and a structure of the impeller 208. As such a fluid connection between the impeller 208 and the bearing cavity 230 is provided.

FIG. 2B illustrates the aircraft engine 200 of FIG. 2A and indicates a flow path of air through the illustrated portion of the aircraft engine 200. As shown, cold or cool air 242 is directed into and through the impeller 208 where the air is compressed. The output from the impeller 208 is compressed air 244 that is directed toward the combustion section of the aircraft engine 200 through the combustion section inlet 210. In accordance with embodiments of the present disclosure, a cooling air 246 may be extracted or bled from the compressed air 244 (e.g., a portion of the compressed air 244) and such cooling air passes through the gap 240 defined between the impeller 208 and the compressor section case 207. In accordance with some non-limiting example configurations, the cooling air 246 that is extracted from the compressed air 224 may be 10% or less of the total flow of the compressed air 224. In such configurations, the remaining 90% or greater is directed toward a combustion system. In accordance with some embodiments, the amount of extracted air may be 5% or less, or in other embodiments in the range of 0.5% to 2% of the flow of the compressed air 224. The gap 240 may be configured to control the amount of cooling air 242 that is bled from the compressed air 224. In some configurations, apertures or through-holes may be provided to control the amount of cooling air 242 that is bled from the compressed air 224. Such apertures or holes may be provided in combination with the gap 240 or in other embodiments, the gap 240 may be defined by machined or specifically formed channels, openings, holes, or the like, to provide the cooling air 242. It will be appreciated that the gap 240 or other similar fluid paths from the impeller 208 to the bearing cavity 230 may be metered or otherwise configured to control an amount of airflow therethrough.

From the gap 240, which may include a radially inward direction of flow, the cooling air 246 will enter the bearing cavity 230 and flow axially aftward toward the turbine section 204. The radially inward flow through and along the gap 240 may be induced by a relatively low pressure within the bearing cavity 230 as compared to the relatively high pressure of the air being compressed by the impeller 208. As the cooling air 246 travels aftward through the bearing cavity 230, the cooling air 246 will then enter the transfer tube 234 of the joint 232 and enter the vane assembly plenum 224. The cooling air 246 may increase in pressure within the vane assembly plenum 224 and flow into and through the transfer tube 222 in the one or more vanes 216 of the vane assembly 217. The cooling air 246 will then enter the containment cavity 220 to provide cooling therein. The cooling air 246 may then bleed into or be directed into the hot gas path 218 downstream from the vane 216.

The vane assembly plenum 224 is described as provided a region for increasing pressure of the cooling air 246. This increase in pressure of the cooling air 246 within the vane assembly plenum 224 can prevent backflow of air through the transfer tube 222 of the vane 216. This configuration also ensures that the containment cavity 220 is maintained at desired pressures.

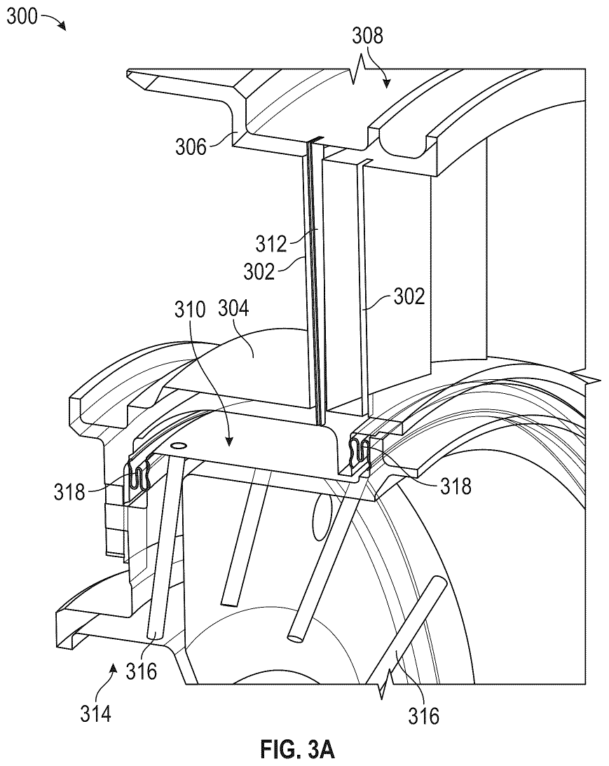

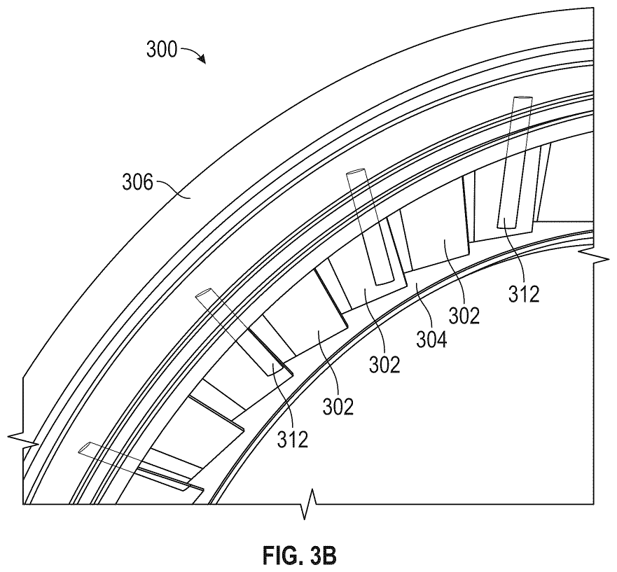

Referring now to FIGS. 3A-3B, schematic illustrations of a vane assembly 300 in accordance with an embodiment of the present disclosure is shown. The vane assembly 300 may be arranged as part of an aircraft engine, similar to that shown and described above. The vane assembly 300 includes a plurality of vanes 302 that are circumferentially distributed about the aircraft engine. The vanes 302 extend in a radial direction (e.g., relative to an engine shaft, engine axis, or engine centerline) between an inner diameter platform 304 and an outer diameter platform 306. A containment cavity 308 (e.g., similar to containment cavity 220 shown in FIGS. 2A-2B) is defined radially outward from the outer diameter platform 306. A vane assembly plenum 310 is defined by or within, at least in part, the inner diameter platform 304. The vane assembly plenum 310 and the containment cavity 308 are fluidly connected by at least one vane transfer tube 312 arranged in at least one vane 302 of the vane assembly 300.

As shown, the vane assembly plenum 310 may be fluidly connected to a bearing cavity 314 (see, e.g., FIGS. 2A-2B) by a plenum transfer tube 316. As shown a plurality of plenum transfer tubes 316 may be arranged in a circumferential arrangement and may be configured to supply a generally circumferentially uniform amount of air from the bearing cavity 314 into the vane assembly plenum 310. As noted above, the vane assembly plenum 310 may be arranged to have an increased pressure to prevent backflow of air through the vane transfer tubes 312. As a result, the air pressure within the vane assembly plenum 310 is greater than an air pressure within the containment cavity 308. Stated another way, a relatively low pressure within the containment cavity 308 will aid in pulling cooling air through the vane assembly plenum 310 and the vane transfer tubes 312. A lower air pressure may exist downstream or aftward within a hot gas path (e.g., hot gas path 218 shown in FIG. 2A). Due to the relatively lower pressure within the hot gas path, the cooling air within the containment cavity 308 will continue to flow aftward and feed or bleed into the hot gas path downstream from the vanes 302 having the vane transfer tubes 312. Accordingly, a continuous flow of cooling air may be supplied into and through the containment cavity 308.

The relatively high pressure within the vane assembly plenum 310 may be maintained by preventing unwanted leakage from the vane assembly plenum 310. Accordingly, one or more seals 318 may be arranged about ends (e.g., forward and aft ends) of the vane assembly plenum 310. In accordance with non-limiting embodiments, and as illustratively shown, the seals 318 may be W-seals. Further, in some embodiments, the seals 318 may be full hoop seals that provide a seal about a full circumference of the vane assembly plenum 310.

As described above, pressurized cool air may be supplied to a containment cavity of an aircraft engine, without adding any tubing or the like which may increase complexity the engine design. In accordance with embodiments of the present disclosure, cooling air may be sourced from an impeller of the aircraft engine and directed through an internal flow path to supply cooling air to a containment cavity. The extracted compressed and cool air may be obtained from a downstream end of an impeller of a compressor section of the aircraft engine. This compressed air will have high pressure but will also be relatively cool or cold, and thus can act as a heat sink and/or cooling flow of air to provide cooling to various components and/or cavities of the aircraft engine. In accordance with embodiments of the present disclosure, the cooling air sourced from the impeller is directed across or through a bearing housing to an aft-end thereof. The cooling air may then pass into and through one or more plenum transfer tubes to supply cooling flow into an optional vane assembly plenum. In accordance with some embodiments, the vane assembly plenum may be omitted, and the cooling flow may be directed directly from the bearing cavity into and through the vane transfer tubes and into the containment cavity. In other embodiments, the vane assembly includes the vane assembly plenum to ensure a high pressure of the cooling air at an upstream side of the vane assembly. Finally, a flow of the cooling air through vane transfer tubes provides cooling air into the containment cavity.

The vane assembly, in accordance with some embodiments of the present disclosure, and as illustratively shown in FIG. 3C, may include a plurality of standard airfoils as well as some airfoils having a passage (e.g., vane transfer tube) that allow the cooling air to flow through the vanes and toward the containment cavity. The size of the vane transfer tubes and/or the plenum transfer tubes may be selected (e.g., hole size, length, etc.) to achieve necessary cooling requirements for the containment cavity.

Advantageously, embodiments described herein provide for improved cooling schemes for aircraft engines. Such improved cooling schemes include the elimination or lack of inclusion of tubing or conduits that are dedicated or specifically configured to supply cooling air into a containment cavity. Rather, an internal flow path of cooling air that is directly sourced from an impeller or compressor section of the aircraft engine is provided. The cooling flow may pass through a bearing cavity and then be directed through one or more airfoils of a turbine section of the aircraft engine. In some embodiments, a vane assembly plenum may be provided to increase a pressure of the cooling air at an upstream location relative to a vane transfer tube, thus ensuring a desired cooling flow into the containment cavity.

The use of the terms “a”, “an”, “the”, and similar references in the context of description (especially in the context of the following claims) are to be construed to cover both the singular and the plural, unless otherwise indicated herein or specifically contradicted by context. The modifier “about” used in connection with a quantity is inclusive of the stated value and has the meaning dictated by the context (e.g., it includes the degree of error associated with measurement of the particular quantity). All ranges disclosed herein are inclusive of the endpoints, and the endpoints are independently combinable with each other. It should be appreciated that relative positional terms such as “forward,” “aft,” “upper,” “lower,” “above,” “below,” and the like are with reference to normal operational attitude and should not be considered otherwise limiting.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments.

Accordingly, the present disclosure is not to be seen as limited by the foregoing description, but is only limited by the scope of the appended claims.

1. An aircraft engine comprising:
a fan section;
a combustion section;
a compressor section comprising an impeller;
a turbine section comprising a vane assembly and a containment cavity defined radially outward from the vane assembly, wherein the fan section, the combustion section, the compressor section, and the turbine section are arranged along an engine axis and an engine shaft operably connects the turbine section to the fan section; and
a bearing housing arranged axially between the compressor section and the turbine section, the bearing housing defining a bearing cavity,
wherein cooling air is supplied from the impeller, through the bearing cavity, through a first transfer tube arranged in a joint that connects the bearing housing to a structure of the turbine section, the first transfer tube fluidly connecting the bearing cavity to a sealed vane assembly plenum defined between the joint and an inner diameter platform at an inner diameter of the vane assembly, through the sealed vane assembly plenum and passed through a second transfer tube arranged within at least one vane of the vane assembly, and into the containment cavity.

2. (canceled)

3. The aircraft engine of claim 1, wherein the bearing housing is connected to a housing of the turbine section at a joint.

4. The aircraft engine of claim 3, wherein the first transfer tube defines a fluid path through the joint.

5. (canceled)

6. The aircraft engine of claim 1, wherein the cooling air is extracted from air compressed by the impeller, wherein a majority of the compressed air is directed to the combustion section.

7. The aircraft engine of claim 1, wherein the cooling air is directed from the impeller into a gap between a structure of the impeller and a portion of a compressor section case of the compressor section.

8. (canceled)

9. The aircraft engine of claim 1, wherein the sealed vane assembly plenum is sealed by at least one seal at forward and aft ends of the sealed vane assembly plenum.

10. The aircraft engine of claim 9, wherein the at least one seal is a W-seal.

11. The aircraft engine of claim 1, wherein an air pressure within the sealed vane assembly plenum is maintained at a pressure greater than an air pressure within the containment cavity.

12. A method for supplying cooling air into a containment cavity of an aircraft engine, the method comprising:
extracting the cooling air from air compressed by an impeller of the aircraft engine;
passing the cooling air aftward from the impeller, through a bearing cavity, through a first transfer tube arranged in a joint that connects a bearing housing to a structure of a turbine section of the aircraft engine and into a sealed vane assembly plenum defined at an inner diameter of a vane assembly between the joint and an inner diameter platform of the vane assembly; and
passing the cooling air radially outward from the sealed vane assembly plenum through a second transfer tube arranged within at least one vane of the vane assembly and into the containment cavity.

13. The method of claim 12, wherein the aircraft engine comprises a fan section, a combustion section, a compressor section comprising the impeller, and a turbine section comprising the vane assembly and the containment cavity is defined radially outward from the vane assembly.

14. The method of claim 13, wherein a bearing housing is arranged between the compressor section and the turbine section and defines the bearing cavity.

15. The method of claim 12, further comprising directing 10% or less of the compressed air to the containment cavity, with the remaining 90% or greater of the compressed air being directed to a combustion section of the aircraft engine.

16. The method of claim 12, wherein the cooling air is directed from the impeller into a gap between a structure of the impeller and a portion of a compressor section case of a compressor section of the aircraft engine.

17. The method of claim 12, further comprising maintaining an air pressure within the sealed vane assembly plenum at a higher air pressure than an air pressure within the containment cavity.

18. The method of claim 12, further comprising sealing the sealed vane assembly plenum with at least one seal at forward and aft ends of the sealed vane assembly plenum.

19. The method of claim 18, wherein the at least one seal is a W-seal.

20. The method of claim 12, further comprising directing the cooling air from the containment cavity into a hot gas path of the aircraft engine.
